(19) United States
(12) Patent Application Publication
(10) Pub. No.: US 2010/0084283 A1
(43) Pub. Date: Apr. 8, 2010

(54) CARBON DIOXIDE SEQUESTRATION AND CAPTURE

(76) Inventor: Rodolfo Antonio M. Gomez, Brompton (AU)

Correspondence Address: KLAUBER & JACKSON, 411 HACKENSACK AVENUE, HACKENSACK, NJ, 07601, US

(21) Appl. No.: 12/595,956

(22) PCT Filed: Feb. 18, 2008
(86) PCT No.: PCT/AU08/00211

§ 371 Date: Oct. 14, 2009

(30) Foreign Application Priority Data
Apr. 20, 2007 (AU) 2007902074
Apr. 23, 2007 (AU) 2007902156
May 4, 2007 (AU) 2007902359
May 7, 2007 (AU) 2007902384

(51) Int. Cl. C01B 31/24; C01D 7/00; C01F 5/24; C01F 11/18; C25B 1/00; C25B 1/04; C25B 1/14; C25B 1/18; C02F 1/461

(52) U.S. Cl. 205/742; 204/250; 204/242; 204/274

(57) ABSTRACT

A process to convert carbon dioxide into a stable substance with electrolytically activated seawater and use this process to sequester carbon dioxide from coal power plants (82) and similar carbon dioxide producing equipment, and capture and sequester carbon dioxide from the atmosphere. Electrolytically activated seawater (92) is produced using a unipolar electrolytic cell (91) and is sprayed into a contacting tower (93) or into the air.

### FIELD OF INVENTION

This invention refers to the sequestration of carbon dioxide from operations producing the carbon dioxide such as coal power plants and ships and the capture and sequestration of carbon dioxide from the atmosphere.

### PRIOR ART

Reports in literature indicate that the majority of workers on the sequestration of carbon dioxide talk of concentration of the gas by either absorption in a liquid such as monoethanolamine or more recently, by nano-filtration using ceramic media. Inevitably, after the carbon dioxide is concentrated, researchers talk of sequestration by storing the concentrated carbon dioxide gas in geological structures, particularly in depleted natural gas fields. The problem with this method of disposal is the limited availability and the location of suitable geological structure to store the carbon dioxide.

Another popular proposal is to store the carbon dioxide gas in deep saline reservoirs. This is a natural choice for storing carbon dioxide produced in gas or oil field located in oceans. The problem with this method of disposal is that not only are availability and location of saline structures a problem for a particular application, but the integrity of the saline structure to store the carbon dioxide safely is difficult to ascertain. The carbon dioxide may unknowingly escape to the ocean to affect the marine environment or be released to the atmosphere due to the up-welling ocean currents.

Mitsubishi Corporation has been attempting for several decades, to develop pumping carbon dioxide deep into the ocean. The concern about this method is the potential harm to the ocean environment of the effect of carbon dioxide and the uncertainty that the carbon dioxide may be brought up to the surface and discharged to the atmosphere in large amounts. There is no successful application of this ocean burial technology at present.

It is the object of this invention to provide an improved carbon dioxide sequestration process or to at least provide an alternative process.

### DESCRIPTION OF THE INVENTION

In one form the invention comprises a process for sequestering carbon dioxide, the process comprising the steps of;

passing seawater through an unipolar electrolytic cell operating in cathode-cathode mode thereby reducing hydrogen ions in the seawater to hydrogen gas resulting in an excess of hydroxyl ions thereby producing an activated seawater and the hydroxyl ions forming hydroxides or bases of metals in the seawater including calcium, magnesium, sodium and potassium to produce activated seawater;
contacting carbon dioxide with the activated seawater thereby forming carbonic acid; and
reacting the carbonic acid with the hydroxides or bases of metals in the seawater to form carbonates of calcium, magnesium, potassium and sodium and water thereby sequestering the carbon dioxide.

Preferably the unipolar electrolytic cell comprises an anode cell assembly and a cathode cell assembly, the anode cell assembly including an anode electrode and an anode solution electrode and the cathode cell assembly including a cathode electrode and a cathode solution electrode, a power supply that provides a DC pulsed current to the anode cell assembly and to the cathode cell assembly and the cathode electrode connected to the power supply, the cathode solution electrode being connected to the anode electrode and the anode solution electrode being connected to the power supply.

Preferably evolution of chlorine in the unipolar electrolytic cell is limited by one or more of methods selected from the group comprising; selecting the gap between the anode and cathode electrodes and their respective solution electrodes; the material coating the solution electrodes; the cell voltage applied; the physical shape of the solution electrodes; and modifying the chemical characteristics of the seawater such as its pH.

Preferably the carbon dioxide is sequestered from operations producing carbon dioxide selected from the group comprising coal or oil or gas fired electric power plants, coal or oil or gas fired furnaces, ships using diesel or coal fuel, stationary diesel fuelled diesel generators, and oil or gas wells producing carbon dioxide.

The seawater may be pre-heated before it is passed through the unipolar electrolytic cell.

The direct current applied to the unipolar electrolytic cell may be pulsing with a frequency of 2 to 200 kilohertz.

In carbon dioxide producing operations, the flue gas containing the carbon dioxide may be contacted with the activated seawater by an absorption column operating near atmospheric pressure or high pressure where the activated seawater is sprayed or introduced at the top of the absorption tower and the flue gas introduced at the bottom of the tower. The absorption device may be a packed tower or a construction similar to a distillation column with several plates.

In the application where carbon dioxide is to be absorbed and sequestered from the atmosphere, the step of contacting carbon dioxide with the activated seawater comprises spraying the activated seawater from the top of a tower. Alternatively the step of contacting carbon dioxide with the activated seawater comprises spraying the activated seawater from the top of a humidified tower to extract carbon dioxide from the air while generating electricity from air turbines installed at the bottom of the humidified tower.

The most readily available liquid for activation is seawater; however, liquids containing cations such as calcium, magnesium, sodium, potassium and others may also be used for activation for a particular location.

In an alternative form the invention comprises an apparatus for sequestering carbon dioxide, the apparatus comprising,

an unipolar electrolytic cell operating in cathode-cathode mode,
a DC power supply to supply power to the unipolar electrolytic cell means to supply seawater to the unipolar electrolytic cell,
means to transfer seawater from the unipolar electrolytic cell to a contacting arrangement, and
means to contact the seawater with carbon dioxide in the contacting arrangement, whereby to sequester carbon dioxide into the seawater.

Preferably the unipolar electrolytic cell comprises an anode cell assembly and a cathode cell assembly, the anode cell assembly including an anode electrode and an anode solution electrode and the cathode cell assembly including a cathode electrode and a cathode solution electrode, a power supply that provides a DC pulsed current to the anode cell assembly and the cathode cell assembly and the cathode electrode connected to the power supply, the cathode solution electrode being connected to the anode electrode and the anode solution electrode being connected to the power supply.

Preferably the power supply comprises modulating means whereby to supply direct current to the unipolar electrolytic cell pulsed with a frequency of 2 to 200 kilohertz and a duty cycle of 30 to 70%.

Preferably the power supply comprises wind or solar or wave power.

There may be further steps including means to preheat the seawater.

The contacting arrangement can comprise of an absorption tower or column, a humidified tower to absorb some of the carbon dioxide or alternatively the contacting arrangement comprises means to spray the seawater from the top of a tower located on a windy island or coast or barge or ship in the ocean.

The humidified tower can comprise of at least two shorter auxiliary carbon dioxide absorption towers connected to the bottom of the humidified tower where more activated seawater is sprayed in contact with the air to absorb more carbon dioxide.

### BRIEF DESCRIPTION OF THE DRAWINGS

This then generally describes the invention but to assist with understanding of the invention reference will now be made to a description of the process and preferred embodiments with the assistance of the accompanying drawings.

In the drawings:

FIG. 1 shows a prior art unipolar electrolytic system acting in anode-cathode mode;

FIG. 2 shows a prior art unipolar electrolytic system acting in cathode-cathode mode suitable for the present invention;

FIG. 3 is a graph of the pH of the anolyte and catholyte when the cells are in the cathode-cathode mode;

FIG. 4A shows a preferred embodiment of electrode construction;

FIG. 4B show detail of a further preferred embodiment of electrode construction;

FIG. 5 shows a graph taken from the FutureGen Project of the US Department of Energy showing the potential for storage of carbon dioxide;

FIG. 6 shows problems with carbon dioxide injection into an under sea saline formations;

FIG. 7 shows a lab scale test of seawater activation and carbon dioxide sequestration;

FIG. 8 shows a carbon dioxide sequestration process for an existing coal fired power station;

FIG. 9 shows a carbon dioxide sequestration process for ships;

FIG. 10 shows a carbon dioxide sequestration process from the atmosphere; and

FIG. 11 shows a carbon dioxide sequestration process for a humidified tower arrangement.

### DESCRIPTION OF THE PROCESS AND PREFERRED EMBODIMENTS

This invention is best described in three parts as follows:
1. A description of the science of seawater activation
2. Sequestration of carbon dioxide from producers of this greenhouse gas
3. Capture and Sequestration of carbon dioxide from the Atmosphere.

### 1. Science of Seawater Activation

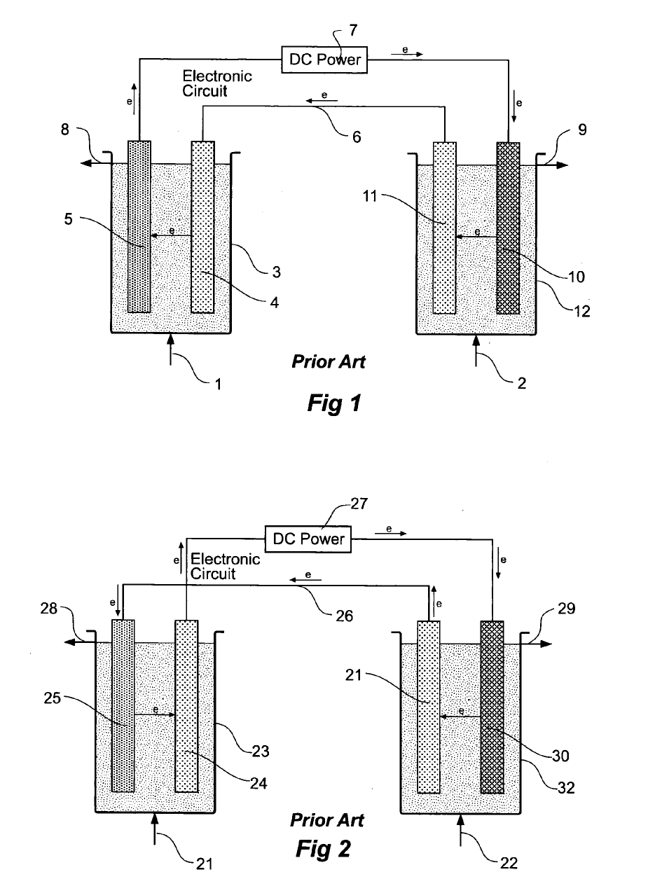

The applicant has been granted U.S. Pat. No. 5,882,502 for an electrolytic cell that functions without a diaphragm. This concept has been used in unbalanced electrolysis or unipolar mode as described in our United Kingdom Patent No. GB 2392441, “Electrolytic Activation of Fluids” and more recently in PCT/AU2007/000809 “Electrolytic Activation of Water”. The diaphragm-less electrolytic cell in unipolar mode is shown in FIG. 1 of this application where oxidizing reactions occur at the anode cell producing acidic water and reducing reactions at the cathode cell producing alkaline water. The applicant has more than 4 years of experience in operating the unipolar cells in anode-anode mode at large laboratory scale and at commercial scale for the disinfection of water where hydrogen peroxide, ozone and radicals are produced as biocides and where the electric power is pulsed at 2 to 50 kilohertz and at 50 to 70% duty cycle. The applicant finds that pulsing DC power at the higher frequency gives better results and less energy is used.

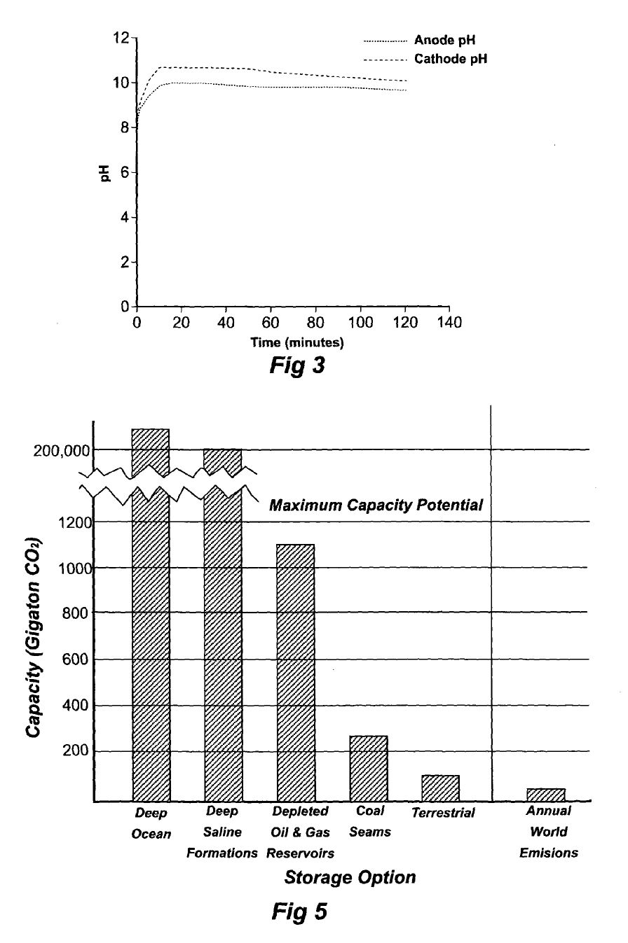

In this invention, the unipolar cells are operated in cathode-cathode mode where reducing conditions are achieved in both cells as shown on FIG. 2. In this cathode-cathode mode, the current is travelling away from the anode electrode and from the cathode electrode. This was confirmed in large scale laboratory testing where the water produced from both cells became alkaline as shown in FIG. 3. While FIG. 2 shows the water separately being fed and exiting from the anode cell in cathode mode and the cathode cell, it is also possible to take the discharge of the anode cell in cathode mode and feed this to the cathode cell since both cells are in reducing mode.

The basic concept in activating seawater for sequestering carbon dioxide starts with making the seawater contain more OH(−) ions by reducing the H(+) ions to hydrogen. This is achieved by the unipolar cells arranged in cathode-cathode mode. When there is excess OH(−) ions, these would react with the calcium, magnesium, sodium and potassium (Ca, Mg, Na, and K) in the seawater to form hydroxides. When carbon dioxide is contacted with the activated seawater, the carbon dioxide reacts with water to form H₂CO₃. The H₂CO₃ reacts with the Ca, Mg, Na, and K hydroxides in a simple acid-base reaction to form water and the carbonates of Ca, Mg, Na, and K. These carbonates are stable compounds and nature has used these carbonates as building blocks over millions of years to form sediments and subsequently mountains. The analysis of seawater taken from CHEMLAB is as follows:

| | |
|---|---|
| Na | 1.352 Wt % |
| K | 0.02825 Wt % |
| Ca | 0.05925 Wt % |
| Mg | 0.30765 Wt % |

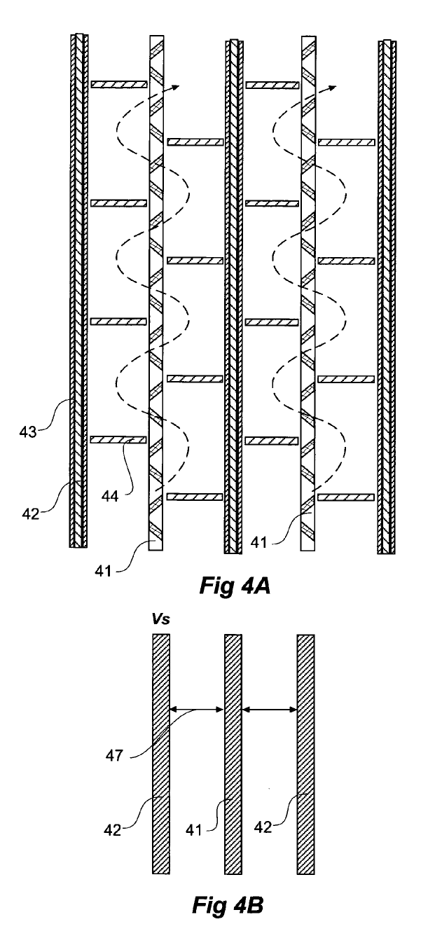

While seawater is the major water used in this sequestration, other water sources that contain sufficient levels of Ca, Mg, Na, and K can also be used for this process. It is not easy to achieve this reaction solely as the seawater contains a number of impurities, particularly chlorine. As shown on FIG. 4, if the conditions are right, the solution electrode behaves as an anode and chlorine may be evolved. This could affect the objective of making the seawater alkaline as chlorine makes the seawater acidic. In the first experiment on Sep. 3, 2007, the hydrogen gas produced was only 72% and the seawater pH became slightly acidic, suggesting that chlorine was produced.

Proposed modifications to the unipolar cell mean that eventually, mostly hydrogen will be produced. This will be by a selection of a solution electrode surface material with a large over-voltage for chlorine, changing the physical shape of the solution electrode, changing the gap between electrodes and the properties of the seawater before electrolysis.

The electrode may, for instance, be coated with a mixture of oxides of titanium, ruthenium and iridium. For suppressing chlorine one such coating may be O₂=11.89%, Ti=18.58%, Ru=64.27 and Ir=3.91%.

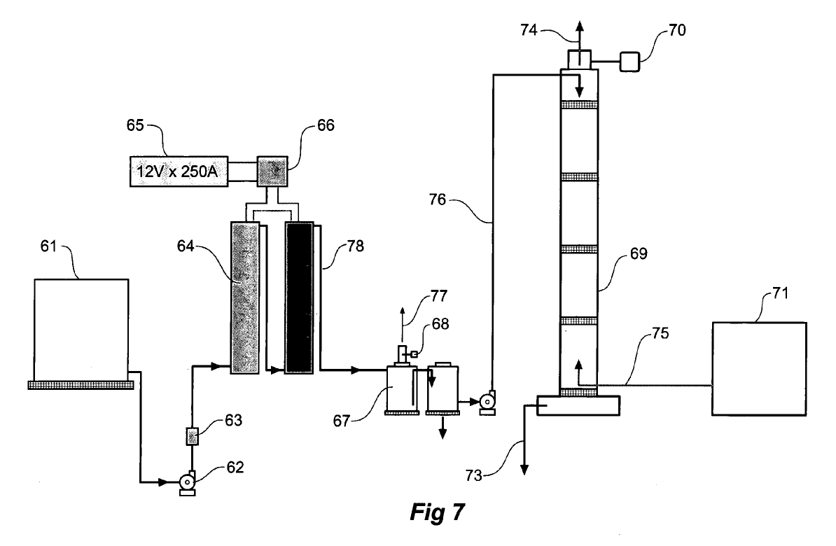

The gap used in the cells on FIG. 7 was 4.7 mm and larger gap between electrodes will be trialled to see if chlorine production can be eliminated if the voltage at the solution electrode is reduced below 1.3595 volts, the Eo for the reaction 2Cl⁻-2e →Cl₂.

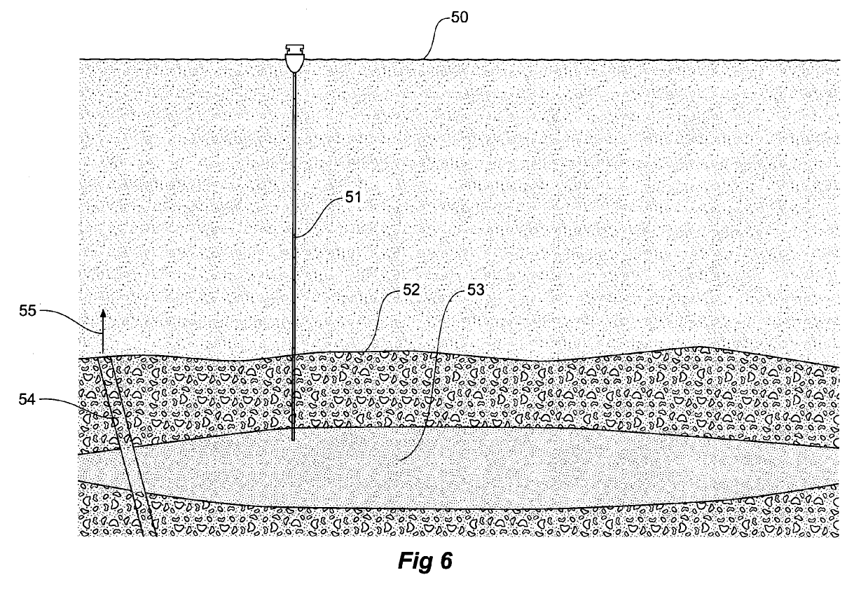

The oceans have a large capacity to store carbon dioxide as shown on FIG. 5 taken from the FutureGen Project of the US Department of Energy. Carbon dioxide in the atmosphere is absorbed mainly at the shallow part of oceans but the oceans have a potential to store about 10,000 years of the current World production of carbon dioxide. The other major potential storage of carbon dioxide is in deep saline structures. The applicant believes that, as shown in FIG. 6, there is uncertainty in the safe storage of carbon dioxide in deep saline structures as the carbon dioxide may escape into the ocean and into the atmosphere through faults or porous structures in the saline formation. This would be difficult to monitor or establish where the leak is occurring.

2. Sequestering Carbon Dioxide from Carbon Dioxide Producers

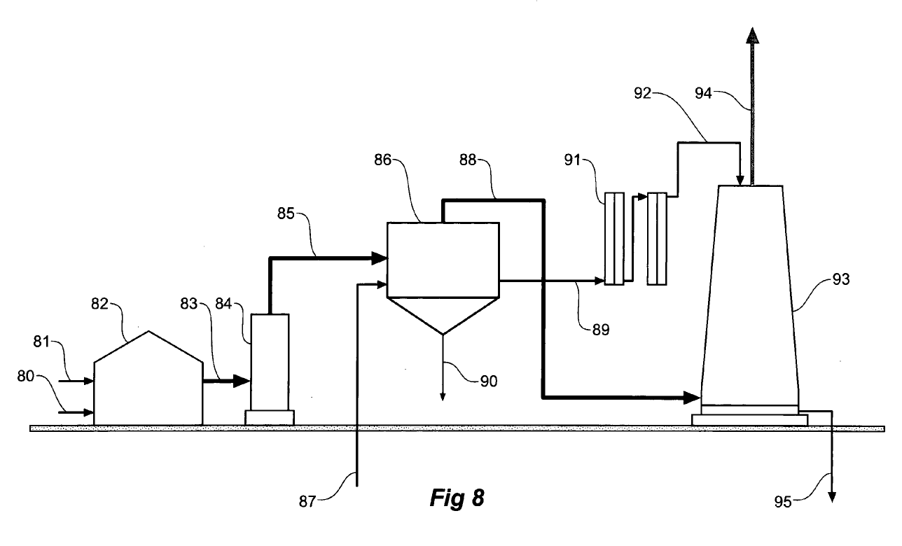

The major carbon dioxide producers are the coal electric power plants. Many of these power plants are located close to oceans so that activated seawater may be used to sequester the carbon dioxide produced. An example of how this is carried out is shown on FIG. 8 where fresh seawater is heated by a flue gas from the electrostatic precipitator prior to activation. The other benefit of this system is that particulates and some toxic substances may be absorbed by the seawater instead of being discharged into the atmosphere.

FIG. 8 shows that case for a simple absorption tower with the activated seawater sprayed at the top of the tower with several mesh type distribution plates but absorption of the CO₂ may also be carried out under pressure or a packed tower. A multi-plate contacting column may also be used.

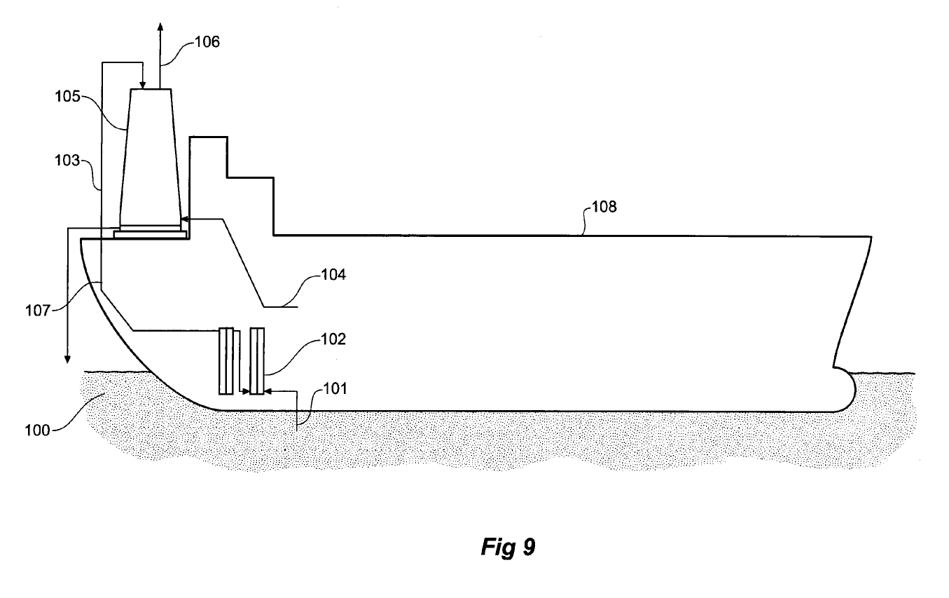

A relatively easy application of this invention is in sequestering carbon dioxide emission from ships travelling the oceans of the World as shown on FIG. 9. Fresh seawater can be accessed by the ship and then activated and passed through an Absorption Tower counter-current to the flue gas of the diesel engines of the ship. The spent seawater is then released back to the surface of the ocean. The ships may be tankers, freighters, ocean liners and military vessels.

Industrial carbon dioxide producers within reasonable access to the oceans may also avail themselves of this sequestration technology.

3. Capture and Sequestering Carbon Dioxide from the Atmosphere

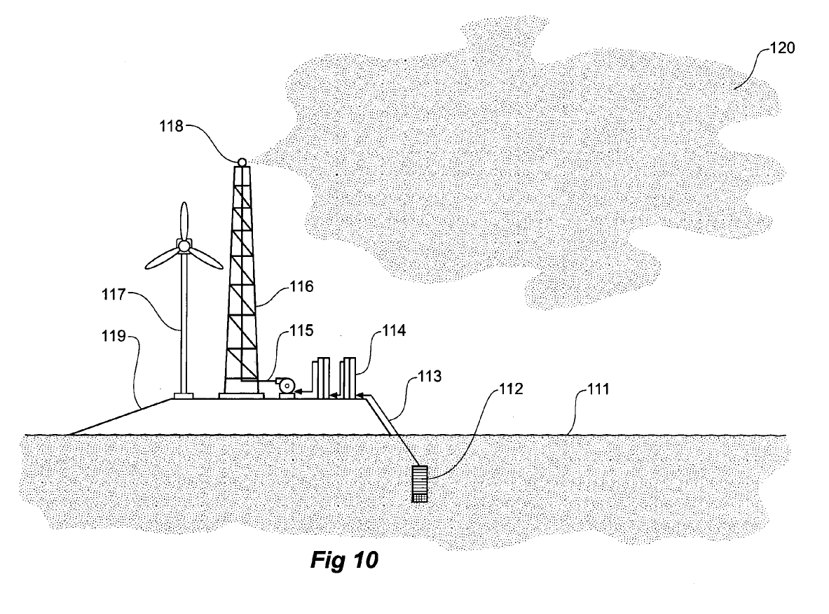

The lower atmosphere is considered to have a uniform carbon dioxide content at present of about 380 ppm by volume. It is often difficult to sequester carbon dioxide from every producer, particularly small and numerous ones such as transport vehicles, domestic coal furnaces as in China and from domesticated and wild animals. It would be more practical to capture and sequester carbon dioxide from the lower atmosphere. Such a set-up is shown on FIG. 10 where the installation may be installed on an island, a coast, on a barge or on a ship at sea. Fresh seawater is pumped through the unipolar cells and then sprayed at the top of a tower. The fine spray of activated seawater contacts with the air and reacts and sequesters the carbon dioxide. The spent spray containing the sequestered carbon dioxide falls back to the ocean. Electric power may be supplied by wind, wave or solar power and the system operates only when there is electric power available. Hydrogen is produced and this may be stored and used as fuel for fuel cells to generate electricity when there is no wind or sun of wave to provide the primary electric power.

In 1975, Dr. Philip Carlson of Lockheed patented a humidified tower but did not proceed to commercialize it. The humidity is very low at the top of the tower at 1,200 metres and when water is sprayed at the top, the air absorbs the water and cools making the air inside the tower heavier than the air outside, and it drops inside the humidified tower. The cool air could develop velocities of 64 to 80 kilometres per hours sufficient to drive electric turbines at the bottom of the tower and produce about 600 megawatts of power. This installation could suck huge amounts of air through the tower.

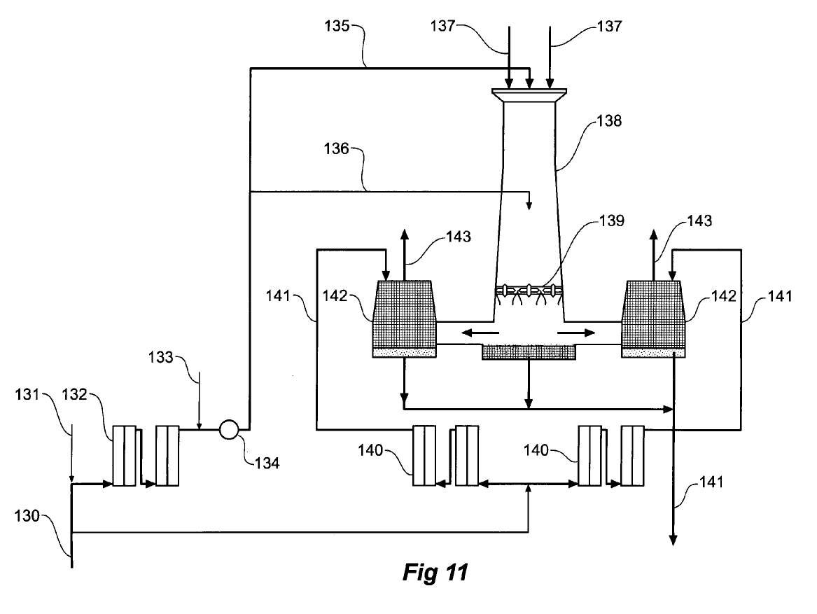

According to the present invention this concept has been modified by using activated seawater that is sprayed at the top of the tower as shown on FIG. 11. The cool air is ideal for the absorption of carbon dioxide. Applicant's calculations indicate that the amount of activated seawater that is ideally sprayed at the top of the tower is insufficient to absorb the CO₂ in the volume of air so that auxiliary shorter towers as shown or tunnels at the base of the tower are required to further absorb the carbon dioxide contained in the air sucked into the humidified tower.

The operating efficiency of the tower is affected between day and night and also between summer and winter. The humidified tower was further studied by Dr. Dan Zavslasky of the Israel Technion Institute with a Tower dimension of 1,200 metres high and 400 metres diameter. The tall tower can be constructed and several ideal locations of the tower have been identified in many countries, Australia among these.

Several towers may be located in one site, say 3 or 4 towers tied together to develop greater structural strength. The tower location may also be staggered over a latitude to provide a more continuous electric power produced. Calculations suggest that there will be excess electric power produced after the power required for pumping and electrolysis are considered. The production of hydrogen fuel is another bonus for this invention.

### DESCRIPTION OF THE DRAWINGS

### FIG. 1

In the normal unipolar electrolytic cell system, water 1 is fed into an anode cell 3 and water 2 is fed separately into a cathode cell 12 and the water discharges separately 8, 9 from the anode cell 3 and cathode cell 12 respectively. The complete electrical circuit starts from the anode electrode 5 to the DC power source 7, to the cathode electrode 10 to the cathode solution electrode 11 to an external conductor 6 to the anode solution electrode 4 and back to the anode electrode 5. Based on experimental results, a pulsing DC electric current achieved better results with less energy than a constant DC current in our electrolytic processes. Applicant believes the reason may be similar to driving a nail in a piece of wood where a tapping force will drive the nail easier and with less force than a constant force.

### FIG. 2

In unipolar electrolytic cell system operating in cathode-cathode mode water 21 is fed into an anode cell 23 and water 22 is fed separately into a cathode cell 32 and the water discharges separately 28, 39 from the anode cell 23 and cathode cell 32 respectively. In the cathode-cathode mode, current flows from the DC power source 27 to the cathode electrode 30 to the cathode solution electrode 31 to the external conductor 26 to the anode electrode 25 to the anode solution electrode 24 and back to the DC power source 27. Note that the cathode-cathode mode is achieved by interchanging the connections between the anode electrode 25 and the anode solution electrode 24.

### FIG. 3

FIG. 3 is a graph of the pH of the anolyte and catholyte when the cells are in the cathode-cathode mode indicating that both cells in reducing mode as shown on FIG. 2 and shows that both anolyte and catholyte show an increase of pH over time.

### FIG. 4

FIG. 4A shows a preferred arrangement of electrodes in the electrolytic cell. In this embodiment, which is applicable to both the anode cell assembly and the cathode cell assembly, the electrode (cathode or anode) 41 is formed from an expanded metal sheet to give it a large surface area, active sites and to encourage turbulent flow over the surface of the electrode. The electrode may be formed from iron, aluminium, or stainless steel (316 or 304 stainless steel) with or without a coating to prevent corrosion and to providing a low over-voltage. Alternatively the electrode may be titanium coated with platinum group oxides. Around the electrode 41 is a baffle arrangement 44. The baffle arrangement 44 is formed from an electrically non-conductive material and is placed to force the water to weave in and out of the expanded metal electrode. Surrounding the baffle arrangement are sheet metal solution electrodes 42. The solution electrodes may be constructed from titanium coated with platinum group oxides or stainless steel (316 stainless steel) or antimonial lead. Water flow through the electrode assembly is shown by the dotted line. It will be seen that the water follows a tortuous path thereby encouraging good contact with the respective electrode. The solution electrode 42 may or may not be covered by a plastic mesh 43 depending on the reactions desired.

As shown in FIG. 4B with the electrolysis of seawater, the gap 47 between the electrode 41 and the solution electrode 42 may be important in reducing the voltage Vs of the solution electrode 42 so that this voltage is below 1.3595 volts to prevent the evolution of chlorine. Coating on the solution electrode 42 is also important to increase the voltage required to evolve chlorine. It is useful to apply a high voltage without evolving chlorine for the reaction kinetics.

### FIG. 5

This is a graph taken from the FutureGen Project of the US Department of Energy showing the potential for storage of carbon dioxide. The most significant potential storage are the oceans of the World and deep saline formations.

### FIG. 6

This diagram shows carbon dioxide injection 51 into and under sea 50 saline formation 53 under the sea floor 52. The major concern about this method of carbon dioxide storage is the uncertainty of the carbon dioxide storage. The carbon dioxide may escape the saline formation through faults or porous structures 54. The escaping carbon dioxide 55 may mix with the ocean water to affect the marine environment or the ocean currents may bring the carbon dioxide to the surface into the atmosphere in large quantities.

### FIG. 7

This diagram describes the large scale laboratory tests on CO₂ sequestration of the flue gas of a diesel engine flue gas on Sep. 3, 2007. Seawater was stored in a 1000 litre tank 61 and then pumped 62 through a flowmeter 63 to unipolar cells 64 with the unipolar cells operated in cathode-cathode mode and powered by a DC power source 65 Model XDC12-250 through a modulator 66 Model PS207 capable of 50 kilohertz. The activated seawater 78 is passed to a hydrogen gas separator 67 where the purity of the hydrogen gas produced 77 is measured by a HY-OPTIMA 700 In-line Process Hydrogen Monitor 68. The hydrogen gas purity indicated was 72%. The activated seawater 76 is then sprayed at the top of a 300 mm dia×6,000 mm high PVC column 69 with several plate screens while flue gas 75 from an ONAN 7 KW diesel generator 71 with a load of 5.6 kilowatts is fed at the bottom of the column 69. The carbon dioxide concentration of the flue gas 74 was measured at the top of the column 69 by an AUSTECH Infrared CO2 Meter Model no. 61-0303LCO2-5 In-line instrument 70. Reading before the seawater was activated was 7.0% CO₂ and the carbon dioxide reading when activated seawater was passed was 4.9% CO₂ giving a sequestration of 30%. Greater sequestration may be achieved by greater activation of the seawater but also by increasing the flow rate of the activated seawater through the column 69. The low purity of the hydrogen gas produced indicated that some chlorine was produced during activation and this was reflected in a slight lowering of the pH of the activated seawater. Further research is required to reduce the production of chlorine during the activation of the seawater.

### FIG. 8

This diagram concerns the sequestration of carbon dioxide from the flue gas of existing coal power plants using activated seawater. Coal 80 and air 81 is used in coal power plant 82 to produce electricity and flue gas 83 which is passed through an electrostatic precipitator 84 to remove solids before the clean flue gas is passed through a heat exchanger 86 fed by fresh seawater 87. Condensate 90 is removed from the heat exchanger 86 while the cooler flue gas 88 is fed to the bottom of the CO₂ absorption tower 93. The heated seawater 89 is passed through the unipolar cells 91 and the activated seawater 92 is fed into the top of the CO₂ absorption tower 93. The flue gas 94 with less carbon dioxide exits at the top of the CO₂ absorption tower 93 while the spent activated water 95 containing the produced carbonates and fine particulates collects at the bottom of the CO₂ absorption tower and is discharged to the ocean or used as feed for desalination.

### FIG. 9

This diagram refers to the sequestration of carbon dioxide from the flue gas of diesel engines driving a ship. Seawater 101 is pumped through unipolar cells 102 and the activated seawater is fed at the top of a ships funnel 105 acting as an absorption tower where the flue gas 104 from the ship's diesel engines is passed counter-current to the activated seawater. The spent seawater 107 after absorbing the carbon dioxide from the flue gas 106 is returned to the ocean 100.

### FIG. 10

This drawing illustrates the use of a spray tower to absorb carbon dioxide from the atmosphere. Seawater 111 is pumped 113 by pump 112 to unipolar cells 114 powered by either wind, solar, or wave power 117 on an island or coast or barge or ship 119. the activated seawater 115 is taken up a spray tower 116 to a spray device 118 where the activated seawater is sprayed into the atmosphere 120, where the fine droplets of activated seawater absorb the carbon dioxide from the atmosphere before falling back to the ocean.

### FIG. 11

This drawing illustrates the use of a humidified tower to suck large volumes of air and contact this with activated seawater to sequester carbon dioxide from the atmosphere. Seawater 130 is pumped through unipolar cells 132 with the addition of reagents 131 and 133. The activated seawater produced by unipolar electrolytic cells 140 is pumped by pump 134 to the top 135 and lower parts 136 of a humidified tower 138 and sprayed into the humidified tower. Air is sucked into the top of the tower as the air is cooled and absorbs the activated seawater, it drops down the humidified tower. Carbon dioxide is absorbed from the air during this process. The falling air drives electric turbines 139 at the bottom of the humidified tower and exits through two or more auxiliary towers 142 where more activated seawater 141 is sprayed at the top of the auxiliary towers 142. The air 143 contains less carbon dioxide than the air 137. The spent activated seawater 144 is returned to the ocean unless it is used for other secondary purposes such as salt making or aquaculture or desalination to produce potable or process water.

1. A process for sequestering carbon dioxide, the process comprising the steps of;
passing seawater through an unipolar electrolytic cell operating in cathode-cathode mode thereby reducing hydrogen ions in the seawater to hydrogen gas resulting in an excess of hydroxyl ions thereby producing an activated seawater and the hydroxyl ions forming hydroxides or bases of metals in the seawater including calcium, magnesium, sodium and potassium to produce activated seawater;
contacting carbon dioxide with the activated seawater thereby forming carbonic acid; and
reacting the carbonic acid with the hydroxides or bases of metals in the seawater to form carbonates of calcium, magnesium, potassium and sodium and water thereby sequestering the carbon dioxide as a metal carbonate.

2. A process as in claim 1 wherein the unipolar electrolytic cell comprises an anode cell assembly and a cathode cell assembly, the anode cell assembly including an anode electrode and an anode solution electrode and the cathode cell assembly including a cathode electrode and a cathode solution electrode, a power supply that provides a DC pulsed current to the anode cell assembly and to the cathode cell assembly and the cathode electrode connected to the power supply, the cathode solution electrode being connected to the anode electrode and the anode solution electrode being connected to the power supply.

3. A process as in claim 2 wherein evolution of chlorine in the unipolar electrolytic cell is limited by one or more of methods selected from the group comprising; selecting the gap between the anode and cathode electrodes and their respective solution electrodes; the material coating the solution electrodes; the cell voltage applied; the physical shape of the solution electrodes and modifying the chemical characteristics of the seawater.

4. A process as in claim 1 wherein the carbon dioxide is sequestered from operations producing carbon dioxide selected from the group comprising coal or oil or gas fired electric power plants, coal or oil or gas fired furnaces, ships using diesel or coal fuel, and stationary diesel fuelled diesel generators.

5. A process as in claim 1 where the seawater is pre-heated before it is passed through the unipolar electrolytic cell.

6. A process as in claim 2 where the direct current applied to the unipolar electrolytic cell is pulsing with a frequency of 2 to 200 kilohertz and a duty cycle of 40 to 70%.

7. A process as in claim 1 wherein the step of contacting carbon dioxide with the activated seawater comprises spraying the activated seawater from the top of a tower.

8. A process as in claim 1 wherein the step of contacting carbon dioxide with the activated seawater comprises spraying the activated seawater from the top of a humidified tower to extract carbon dioxide from the air while generating electricity from air turbines installed at the bottom of the humidified tower.

9. A process as in claim 1 wherein the carbon dioxide is sequestered from operations producing carbon dioxide selected from the group comprising coal or oil or gas fired electric power plants, coal or oil or gas fired furnaces, ships using diesel or coal fuel, and stationary diesel fuelled diesel generators.

10. An apparatus for sequestering carbon dioxide, the apparatus comprising, an unipolar electrolytic cell operating in cathode-cathode mode,
a DC power supply to supply a pulsing power to the unipolar electrolytic cell means to supply seawater to the unipolar electrolytic cell,
means to transfer seawater from the unipolar electrolytic cell to a contacting arrangement, and
means to contact the seawater with carbon dioxide in the contacting arrangement, whereby to sequester carbon dioxide into the seawater.

11. An apparatus as in claim 10 wherein the unipolar electrolytic cell comprises an anode cell assembly and a cathode cell assembly, the anode cell assembly including an anode electrode and an anode solution electrode and the cathode cell assembly including a cathode electrode and a cathode solution electrode, a power supply that provides a DC pulsed current to the anode cell assembly and the cathode cell assembly and the cathode electrode connected to the power supply, the cathode solution electrode being connected to the anode electrode and the anode solution electrode being connected to the power supply.

12. An apparatus as in claim 11 where the power supply comprises modulating means whereby to supply direct current to the unipolar electrolytic cell pulsed with a frequency of 2 to 200 kilohertz and a duty cycle of 40 to 70%.

13. An apparatus as in claim 10 where the power supply comprises wind or solar or wave power.

14. An apparatus as in claim 10 further including means to preheat the seawater.

15. An apparatus as in claim 10 wherein the contacting arrangement comprises an absorption tower or column.

16. An apparatus as in claim 10 wherein the contacting arrangement comprises means to spray the seawater from the top of a tower located on a windy island or coast or barge or ship in the ocean.

17. An apparatus as in claim 10 wherein the contacting arrangement comprises a humidified tower to absorb some of the carbon dioxide.

18. An apparatus as in claim 17 wherein the humidified tower comprises at least two shorter auxiliary carbon dioxide absorption towers connected to the bottom of the humidified tower where more activated seawater is sprayed in contact with the air to absorb more carbon dioxide.
